(19) United States
(12) Patent Application Publication
(10) Pub. No.: US 2025/0196405 A1
(43) Pub. Date: Jun. 19, 2025

(54) SYSTEM AND METHOD FOR DYNAMIC CURING OF COMPOSITE PARTS

(71) Applicant: Spirit AeroSystems, Inc., Wichita, KS (US)

(72) Inventors: Richard Meusborn, Wichita, KS (US); Iain Kennedy, Wichita, KS (US)

(21) Appl. No.: 18/541,308

(22) Filed: Dec. 15, 2023

(51) Int. Cl. B29C 35/02

(52) U.S. Cl. CPC B29C 35/0288; B29C 2035/0211; B29C 35/0227

(57) ABSTRACT

Methods and systems for forming a composite part and controlling an amount of time heat is applied for curing composite material. The method may include applying thermocouples to a plurality of locations on a composite material, applying curing heat to the composite material, determining a predicted percentage of cure of the composite material, and removing heat from the composite material when the predicted percentage of cure reaches a predetermined percentage of cure. Determining the predicted percentage of cure may be performed at predetermined time intervals and determined based on a current temperature sensed by one of the thermocouples and a curing model corresponding to the type of material the composite material comprises. The method may also include training the curing model for a range of different thermal ramp up speeds and hold temperatures via differential scanning calorimetry (DSC) of a polymer sample of a known weight or other training methods.

### BACKGROUND

Composite parts for use in aircraft manufacturing and the like are cured via consolidation pressure and heat. Current composite curing specifications define the entire curing process by a length of time (cure temperature hold) at which a composite material must be held before it can be considered cured.

Thermocouples allow for monitoring of the temperature at a particular region of the composite material during curing. The defining temperature which is monitored for determining how long a composite is held at a curing temperature is referred to as a “lagging thermocouple”. The lagging thermocouple is the coolest zone on the composite. The lagging zone is monitored because it will take the longest to cure, since lower hold temperatures lead to longer cure times. Once a lagging thermocouple comes into a desired temperature range, the countdown to complete cure begins (i.e., the temperature is held at that point for a predetermined amount of time). However, it is often the case that the lagging thermocouple continues to heat up while in this hold portion of the cure cycle, which can result in a reduction in the time actually needed for curing of the composite material. Nevertheless, current composite specifications require holding at a specific temperature for a specific amount of time with no exceptions. In other words, the cure time in prior art composite curing methods is a predefined recipe that does not take the phenomenon of continued heat variations into consideration once the lagging thermocouple comes into the desired temperature range.

Unfortunately, this can lead to many areas of composite structures becoming warped for being held in cure too long, lowering part quality and potentially causing assembly issues between parts. Furthermore, this can lead to high power consumption equipment (like an autoclave) running for unnecessary amounts of time, as well as excess overtime required to monitor an entire cure process from start to finish, well beyond a standard work shift. On the other hand, under-cured sections of a composite part are often required to be cured again at temperature which can once again result in over-curing, because the part begins already partially cured.

Therefore, there is a need for a system and method for curing composite material that does not suffer from these and other deficiencies of the prior art.

### SUMMARY

A method for forming a composite part and controlling an amount of time heat is applied for curing composite material in accordance with an embodiment of the invention includes applying thermocouples to a plurality of locations on a composite material, applying curing heat to the composite material, determining a predicted percentage of cure of the composite material, and removing heat from the composite material when the predicted percentage of cure reaches a predetermined percentage of cure. Determining the predicted percentage of cure may be performed at predetermined time intervals and determined based on a current temperature sensed by one of the thermocouples and a curing model corresponding to the type of material the composite material comprises.

In another embodiment, a system for manufacturing a composite part, includes a composite material, thermocouples at a plurality of locations on the composite material, a heat source to apply curing heat to the composite material, and a processor. The processor is at least one of electrically and communicably coupled to the heat source and the thermocouples. The processor may execute the following code segments: a) identify one of the thermocouples with a lower temperature than all others of the thermocouples after a predetermined time segment as a lagging thermocouple, b) determine at predetermined time intervals a predicted percentage of cure of the composite material based on a current temperature sensed by the lagging thermocouple, what type of material the composite material comprises, and a curing model for the type of material the composite material comprises, and c) instruct the heat source to turn off when the predicted percentage of cure reaches a predetermined percentage of cure.

In yet another embodiment, a computer-implemented method for controlling curing time of a composite part includes receiving, with a processor, a plurality of temperature readings from a plurality of thermocouples located at a plurality of locations on a composite material, while curing heat is applied to the composite material by a heat source. This computer-implemented method further includes identifying, with the processor, one of the plurality of thermocouples with a lower temperature than all others of the plurality of thermocouples, after a predetermined time segment, as a lagging thermocouple. Additionally, the computer-implemented method includes generating at predetermined time intervals, via the processor, a predicted percentage of cure of the composite material based on a current temperature sensed by the lagging thermocouple and a curing model for the type of material the composite material comprises. The computer-implemented method also includes instructing, via the processor, the heat source to stop heating the composite material when the predicted percentage of cure reaches a predetermined percentage of cure.

This summary is intended to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in more detail below with reference to the attached drawing figures, wherein:

FIG. 1 is a schematic view of a system for curing a composite part, constructed in accordance with various embodiments of the present invention;

FIG. 2 is a schematic view of an alternative system for curing a composite part, constructed in accordance with various embodiments of the present invention;

FIG. 3 is a flow diagram illustrating an example method of curing a composite part, in accordance with various embodiments of the present invention;

FIG. 4 is a flow diagram illustrating an example curing method performed by one of the systems for curing the composite part, such as the systems depicted in FIGS. 1 and 2, in accordance with various embodiments of the present invention; and

FIG. 5 is a chart depicting an example temperature ramp up and degree of cure of a composite part.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The embodiments are intended to describe aspects of the invention in sufficient detail to enable those skilled in the art to practice the invention. Other embodiments can be utilized, and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the present technology can include a variety of combinations and/or integrations of the embodiments described herein.

Embodiments of the present invention are generally directed to systems and methods for dynamically curing a composite part based on live, real-time temperature readings and a curing model for a type of composite material being cured. The systems described herein may be utilized to perform any or all of the process steps described below. The methods described herein use specific polymer cure kinetics to dynamically predict a length of time to competition of cure and/or a current degree of cure obtained. By tracking the changes and lengths of time a composite material has been cured at for different temperatures, the percent of cure a composite part has achieved can be predicted in addition to how long it will take the part to reach a desired or predetermined percentage of cure, as opposed to prior art cure recipe methods that simply hold at a particular curing temperature for a set length of time.

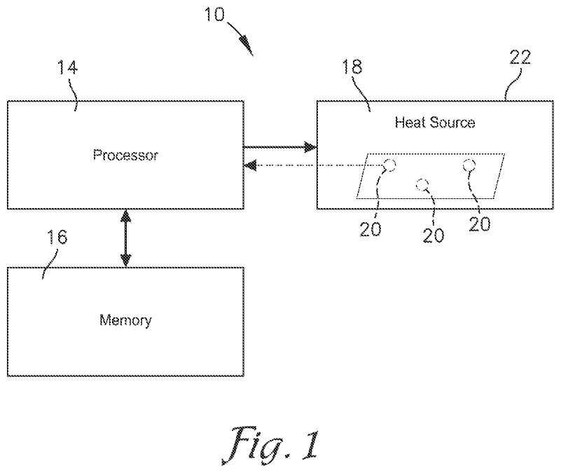

In one or more embodiments, as depicted in FIG. 1, a system 10 for curing a composite part 12 may include a control system having a processor 14 and a memory 16. For example, the control system may include one or more of a computer, tablet, laptop, server, or other controller configured to render a layup model. The system 10 further comprises a heat source 18 and a plurality of thermocouples 20.

The processor 14 and/or the memory 16 may be configured to store and/or automatically perform any of the method steps described later herein. The processor 14 and/or the memory 16 may be embodied by any one or more electronic devices, such as computer servers, workstation computers, desktop computers, laptop computers, palmtop computers, notebook computers, tablets or tablet computers, smartphones, mobile phones, cellular phones, or the like. Specifically, the processor 12 may comprise one or more processors and may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processor 12 may generally execute, process, or run instructions, code, code segments, code statements, software, firmware, programs, applications, apps, processes, services, daemons, or the like. The processor 12 may also include hardware components such as registers, finite-state machines, sequential and combinational logic, configurable logic blocks, and other electronic circuits that can perform the functions necessary for the operation of the current invention. In certain embodiments, the processor 14 may include multiple computational components and functional blocks that are packaged separately but function as a single unit. In some embodiments, the processor 14 may further include multiprocessor architectures, parallel processor architectures, processor clusters, and the like, which provide high performance computing. The processor 14 may be in electronic communication with the other electronic components through serial or parallel links that include universal busses, address busses, data busses, control lines, and the like. The processor 14 may be operable, configured, or programmed to perform the method steps described later herein by utilizing hardware, software, firmware, or combinations thereof.

The processor 14 may include and/or communicate with other processors, the memory 16, the heat source 18, and/or the thermocouples 20 via communication elements and/or user interfaces known in the art, such as keyboards, a mouse, a trackball, a touch screen, input ports, wireless communication devices, or the like. Various communication elements may allow the exchange of data with other computing devices, external systems, networks, and the like. The communication element may include signal and/or data transmitting and receiving circuits, such as antennas, amplifiers, filters, mixers, oscillators, digital signal processors (DSPs), and the like. The communication element may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the communication element may utilize communication standards such as ANT, ANT+, Bluetooth™ low energy (BLE), the industrial, scientific, and medical (ISM) band at 2.4 gigahertz (GHz), or the like. Alternatively, or in addition, the communication element may establish communication through connectors or couplers that receive metal conductor wires or cables which are compatible with networking technologies such as ethernet. In certain embodiments, the communication element may also couple with optical fiber cables. The communication element may be in electronic communication with the memory 16, the processor 14, the heat source 18, and/or the thermocouples 20.

The memory 16 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory 16 may be embedded in, or packaged in the same package as, the processor 14. The memory 16 may include, or may constitute, a non-transitory “computer-readable medium”. The memory 16 may store the instructions, code, code statements, code segments, software, firmware, programs, applications, apps, services, daemons, or the like that are executed by the processor 14. The memory 16 may also store data that is received by the processor 14 or the device in which the processor 14 is implemented. The processor 14 may further store data or intermediate results generated during processing, calculations, and/or computations as well as data or final results after processing, calculations, and/or computations. In addition, the memory 16 may store settings, data, documents, curing models, other statistical models, layup models, production models, other instructions, photographs, videos, images, databases, and the like.

In some embodiments, the memory 16 may be configured to store any of the steps described herein for execution by the processor 14, such as 1) identify one of the thermocouples with a lower temperature than all others of the thermocouples after a predetermined time segment as a lagging thermocouple; 2) determine at predetermined time intervals a predicted percentage of cure of the composite material based on a current temperature sensed by the lagging thermocouple, what type of material the composite material comprises, and a curing model for the type of material the composite material comprises, and 3) instruct the heat source to turn off when the predicted percentage of cure reaches a predetermined percentage of cure. The memory 16 may also store one or more curing models as described herein. Each of the curing models may be a statistical model developed by testing, for a range of different thermal ramp up speeds and hold temperatures, differential scanning calorimetry (DSC) of a particular type of material (e.g., a polymer or matrix material) that the composite material comprises to determine an amount of energy the polymer outputs per unit mass.

The heat source 18 is configured to apply curing heat to the composite material 12 and may be electrically and/or communicably coupled with the processor 14. When the processor 14 determines that a pre-determined percentage of cure has been reached for the composite material 12, the processor 14 may be configured to shut off the heat source 18 or instruct the heat source 18 to reduce the heat output thereby. However, in other alternative embodiments the heat source 18 is not communicably coupled with the processor 14 and output from the processor 14 is used by an operator to determine when to manually shut off the heat source 18, reduce heat provided by the heat source 18, or otherwise remove the composite material 12 from the heat of the heat source 18.

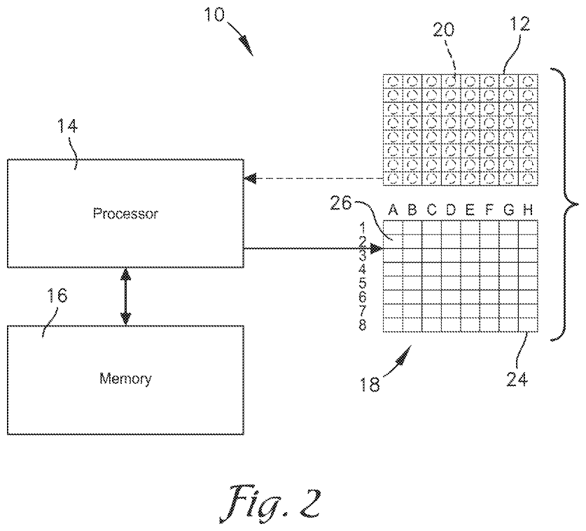

The heat source 18 may include an autoclave or oven 22, as depicted in FIG. 1, or may, as depicted in FIG. 2, alternatively comprise a heat plate 24 with a plurality of heat zones 26 each independently controlled for different temperatures, as later described herein. The heat plate 24 may, for example, be controlled by the processor 14, with each of the heat zones 26 being independently turned on or off or controlled to be set to various temperatures independently, as later described herein. In other embodiments not depicted here, the heat source 18 may include various joule heating methods or other heating methods known in the art without departing from the scope of the invention as described herein.

The thermocouples 20 may include one or more temperature sensors or thermometers known in the art and may be applied to a plurality of locations on the composite material 12. In some embodiments, the thermocouples 20 are embedded in the composite material 12 and may be wired to the processor 14 and/or may be in wireless communication with the processor 14. This may include, for example, placing the thermocouples between layers of the composite material 12. However, in other embodiments, the thermocouples may be placed on top of the composite material 12 and/or places below the composite material 12 without departing from the scope of the invention as described herein.

The thermocouples 20 may include a lagging thermocouple, which could be any of the thermocouples 20 that has a lower temperature than all others of the thermocouples 20 after a predetermined time segment. This can be known in advance and preset in the processor 14 and/or the memory 16, such that values received from the lagging thermocouple are used as later described herein, or the lagging thermocouple may be identified by the processor 14 during the curing process by comparing each of the thermocouples' readings with each other once the predetermined time segment has passed. For example, historical composite data points for similar parts may be used to determine which ones of the thermocouples 20 (based on their location on the composite material) is typically lagging or slowest recording points to reach the cure temperature desired, and the processor 14 may identify that as the lagging thermocouple.

The methods and systems according to embodiments of the present invention provide for an objective characterization and iterative optimization of a heating cure process for composite materials. Embodiments of the present invention overcome the problems with the traditional approach of following a standard recipe of ramp and hold times that sometimes result in overcuring and wasting resources in the process. These problems are overcome by providing an analytical, live, real-time approach that is suitable for curing the composite part by just the right amount, based on a curing model and live temperature readings to determine a predicted percentage of cure of the part and not only the passage of time.

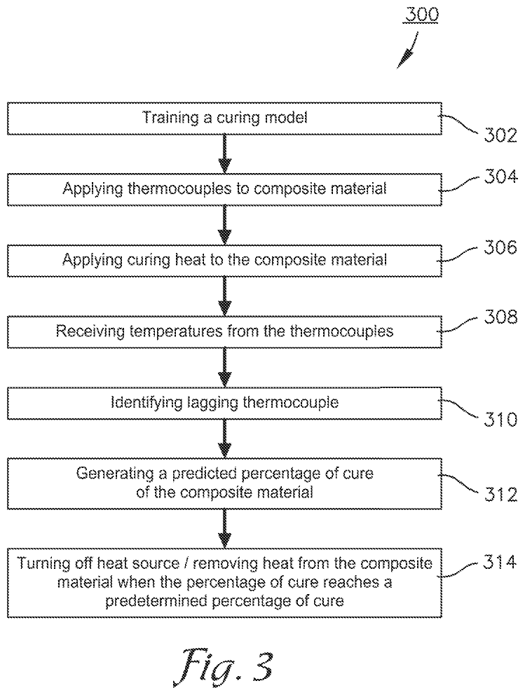

The flow chart of FIG. 3 depicts in more detail the steps of an exemplary method 300 for curing a composite part according to one or more embodiments of the present invention. In some embodiments of the invention, various steps may be omitted and/or steps may occur out of the order depicted in FIG. 3 without departing from the scope of the invention. For example, two blocks shown in succession in FIG. 3 may in fact be executed substantially concurrently, or blocks may sometimes be executed in the reverse order depending upon the functionality involved. The steps may be performed by the processor 14 of the system 10 and/or other components of system 10 via hardware, software, firmware, or combinations thereof. Furthermore, the steps may be implemented as instructions, code, code segments, code statements, a program, an application, an app, a process, a service, a daemon, or the like, and may be stored on a computer-readable storage medium, such as the memory 16.

In one or more embodiments, the method 300 includes training a curing model, as depicted in block 302. However, in other embodiments, curing models may already be pretrained and merely accessed in the memory 16. The training comprises determining an amount of energy a polymer sample (or other type of material of a composite part) outputs per unit mass for a range of different thermal ramp up speeds and hold temperatures via DSC of the polymer sample or other material samples of a known weight. This may be performed for a plurality of different types of material or polymer samples, and a one of the curing models used for the steps described herein may correspond to a polymer sample being a same type of material that the composite material 12 comprises. In some example embodiments, the step depicted in block 302 may comprise training the curing model based on one or more estimated kinetic parameters identified by a differential scanning calorimeter using the Borchardt and Daniels Method as described in: Borchardt, H. J., Daniels, F., Journal of the American Chemical Society, Vol 79, 1957, pp. 41-46 and/or ASTM E2041-13(2018).

For example, the training may involve a test method for determining the kinetic parameters of activation energy, where a test specimen or test sample (also described herein as a polymer sample) is heated at a linear rate in a differential scanning calorimeter through a region of exothermic reaction behavior. The rate of heat evolution, developed by a chemical reaction, is proportional to the rate of reaction. Integration of the heat flow as a function of time yields the total heat of a reaction. The Borchardt and Daniels Method identified above may be used to derive the kinetic parameters of activation energy, Arrhenius pre-exponential factor, and reaction order from the heat flow and total heat of reaction of the test specimen or test sample. However other chemical properties may be tested using other methods known in the art for each of the types of materials, test samples, or polymer samples for a variety of temperature readings at various points during chemical processes that occur during curing of those sample materials to train or otherwise develop the curing model.

In one or more embodiments, the method 300 includes applying the thermocouples 20 to a plurality of locations on the composite material 12, as depicted in block 304, applying curing heat to the composite material 12, as depicted in block 306, and receiving with the processor 14 a plurality of temperature readings from the thermocouples 20, as depicted in block 308, while curing heat is applied to the composite material. The thermocouples can be applied to a variety of locations on the composite material and/or embedded into the composite material. However, in some alternative embodiments, the step depicted in block 304 can be omitted, such as when this step was previously performed via other methods or systems during layup of the composite material 12. The heat can be provided via the heat source 18, as described above. Applying the curing heat may comprise ramping up to a cure temperature at a predetermined rate and holding at the cure temperature until the predicted percentage of cure reaches the predetermined percentage of cure. In embodiments where multiple independent zones of a heat source are used, each of the heat zones may be activated in a predetermined order or substantially simultaneously at the same or different ramping times, depending upon the specifications of the composite part being cured. Furthermore, at least some of the thermocouples 20 may be located at different ones of the heat zones or at a portion of the composite material in contact with different ones of the heat zones.

In some embodiments, the method 300 further includes a step of identifying one of the thermocouples with a lower temperature than all others of the thermocouples, after a predetermined time segment, as a “lagging thermocouple,” as depicted in block 310. However, this step depicted in block 310 may be omitted in some embodiments where the lagging thermocouple is preset or already known and assigned prior to heating the composite part 12. Additionally or alternatively, in embodiments with a plurality of heating zones, the lagging thermocouple may be determined for each of those zones and/or there may be only one thermocouple for each zone, such that each of the thermocouples is considered a lagging thermocouple for purposes of the remaining steps described herein.

Furthermore, one or more embodiments of the method 300 include generating a predicted percentage of cure of the composite material, as depicted in block 312, and removing heat from the composite material 12 when the predicted percentage of cure reaches a predetermined percentage of cure, as depicted in block 314. The generating step of block 312 may be performed at predetermined time intervals, and the predicted percentage of cure of the composite material may be based on a current temperature sensed by the lagging thermocouple (or another one or more of the thermocouples 20), what type of material the composite material 12 comprises, and/or a curing model corresponding to the type of material the composite material 12 comprises. The step depicted in block 312 may be performed iteratively, setting a new floor every time, as the composite material cannot go down in its cure state, only up.

The predetermined percentage of cure at which the heat may be removed may be based on specific part requirements (e.g., structural characteristics, strength characteristics, and the like). Both the predetermined percentage of cure at which the heat may be removed and the curing model may be accessed by the processor 14 via the memory 16, for example.

In one or more embodiments, the curing model is a statistical model developed by testing, for a range of different thermal ramp up speeds and hold temperatures, DSC of the type of material that the composite material comprises (e.g., a polymer or matrix of the composite material) to determine an amount of energy that type of material outputs per unit mass. Additionally or alternatively, the statistical model can be developed by using a dynamic mechanical analysis (DMA) test method or the like. Mechanical testing may also be used to validate the statistical model. The curing model can be developed during the step depicted in block 302 or may be otherwise developed and saved in the memory 16 prior to the method 300 described herein.

In some embodiments, the generating step of block 312 further comprises receiving input regarding the type of material that the composite material is comprised of and selecting the curing model from a plurality of statistical models based on the type of material. That is, in one or more embodiments, the curing model may be selected (e.g., based on user input) from a plurality of statistical models each developed by testing, for a range of different thermal ramp up speeds and hold temperatures at various time intervals, DSC for one of a plurality of types of material (e.g., polymers, matrix materials, etc.) to determine an amount of energy the one of the plurality of types of material outputs per unit mass. Thus, the plurality of statistical models may simulate a sample of a known material type and a known weight at a range of thermal ramps and hold temperatures. Furthermore, in some embodiments, the step depicted in block 312 further includes interpolating data associated with the curing model to predict a cure kinetic state of a matrix of the composite material 12 and/or an amount of time left before the predicted percentage of cure reaches the predetermined percentage of cure. The predicted percentage of cure and the time left before the predicted percentage of cure reaches the predetermined percentage of cure may be output onto a user interface or display associated with and/or communicably coupled with the processor 14. In some embodiments, the processor 14 may also determine other material values of the composite material 12 at one or more of the time intervals based on the predicted percentage of cure at that time interval.

The step depicted in block 314 of removing heat from the composite material 12 may involve instructing the heat source 18 to stop heating the composite material when the predicted percentage of cure reaches the predetermined percentage of cure. For example, when the processor 14 determines that the predetermined percentage of cure has been reached, it may instruct the heat source 18 to turn off, stop outputting heat, or to reduce the heat provided by the heat source 18. In some embodiments, such as when the system depicted in FIG. 2 is used, the steps depicted in blocks 312 and 314 specifically include determining, at the predetermined time intervals, zone-specific predicted percentages of cure of the composite material 12 on each of the plurality of heat zones based on temperatures sensed by each of the thermocouples and the curing model and instructing each of the plurality of zones of the heat source independently to turn off when a corresponding one of the zone-specific predicted percentages of cure reaches the predetermined percentage of cure.

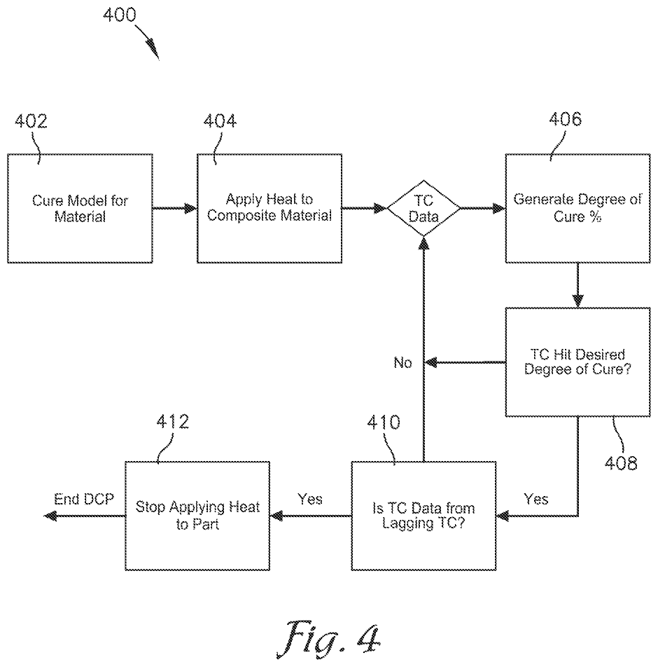

Each of the steps described above and depicted in the blocks of FIG. 3 may be performed by one or more components of the system 10 as depicted in FIG. 1 and/or in FIG. 2. Likewise, FIG. 4 depicts a flow diagram illustrating an example dynamic curing protocol (DCP) or dynamic curing method 400 performed by components of the system 10 as depicted in FIG. 1 and alternatively as depicted in FIG. 2. Specifically, the method 400 includes the steps of training and/or otherwise receiving a cure model for a particular type of material or composite material, as depicted in block 402. For example, the processor 14 may receive the cure model from the memory 16. Additionally or alternatively, the processor 14 may be configured to train the cure model, store the cure model in the memory 16, and/or later access the cure model from the memory 16 when a user inputs the type of material to be cured.

The method 400 further includes instructing the heat source 18 to apply heat to the composite material 12, as depicted in block 404, and based on received thermocouple data and the cure model, generating a real time degree of cure percentage, as depicted in block 406. The method 400 continues performing the method step depicted in block 406 at predetermined intervals of time until: a desired degree of cure is reached for one of the thermocouples, as determined in a method step depicted in block 408, and that that one of the thermocouples is the lagging thermocouple, as described above and determined in a method step depicted in block 410. Once both of the conditions depicted in blocks 408 and 410 are met, the method 400 includes ceasing application of heat to the composite material 12, as depicted in block 412. This may be performed, for example, in an automated manner by the processor 14 providing instructions to the heat source 18 to turn off and/or reduce or otherwise remove heat applied to the composite material 18.

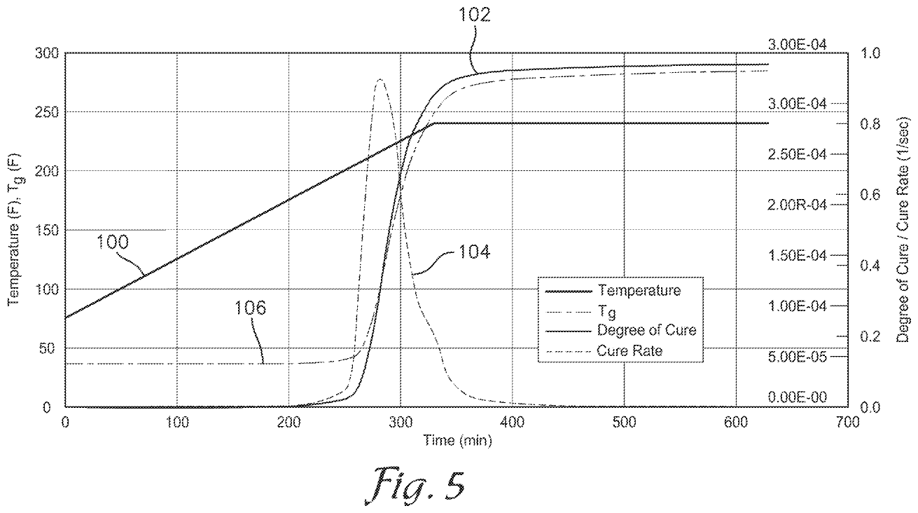

FIG. 5 is a chart with a first line 100 depicting a simulated temperature from the heat source 18 with a slow ramp up time, and a second line 102 depicting a degree of cure of the composite material 12 as a function of temperature. Furthermore, FIG. 5 depicts a third line 104 that represents a cure rate, which is fastest in this example scenario just before the hold temperature is reached by the simulated temperature (e.g., first line 100). As can be seen in FIG. 5, the target minimum hold temperature is not necessarily when the fastest curing occurs. FIG. 5 also depicts a fourth line 106 representing the glass transition temperature (Tg), which changes as thermosetting materials cure. Note that with a slow ramp up to the desired hold temperature to show the impact of ramp rate on cure rate, more of the composite material 12 is cured during the ramp up time period than if the ramp up is fast (i.e., a short amount of time), which can also impact the amount of hold time required to hit a predetermined percentage of cure. In some embodiments, the predetermined percentage of cure could be at least 99%, while in other embodiments the predetermined percentage of cure to reach before removing the heat from the composite material may be at least 96% or at least 94%. The precise degree of cure required to stop heating the composite material 12 depends on the desired mechanical properties or specification of the type of material being cured or the final part specifications. Note that each of the variables charted in FIG. 5 may be control perimeters for the methods described herein. Specifically, in addition to temperature, cure rate, degree of cure, and/or Tg may be control parameters for the processes or methods described herein, allowing for more tailored cure processes depending upon a desired or required level of specificity.

Advantageously, the methods described herein allow for substantial efficiency improvements for composite curing processes and may reduce secondary bond or other additional cure times. Improved composite quality by a reduction in any over-curing allows for higher composite standards to be made as well. Furthermore, some embodiments described herein allow for a multiple heating zone composite manufacturing process to consider each zone independently and track the progress of each zone's cure precisely according to unique polymer properties and other variations throughout the part such as variable thicknesses.

Although the invention has been described with reference to example embodiments illustrated in the attached drawing figures, it is noted that equivalents may be employed, and substitutions made herein without departing from the scope of the invention as described and claimed herein.

For instance, it should be noted that composite parts are typically formed from composite material, as is known in the art, which generally includes at least two constituent components-a reinforcement material and a matrix material. The reinforcement material generally provides mechanical strengthening properties, such as high tensile strength, to the composite material, while the matrix material acts as a binder to hold the reinforcement material together. The reinforcement material and the matrix material may possess additional properties not discussed herein. Furthermore, the composite material may include additional components not discussed herein. In some embodiments, the type of material referred to in the method steps above may refer to the matrix material of the composite material.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processing elements need not be configured or instantiated at any one instance in time. For example, where the processor comprises a general-purpose processor configured using software, the general-purpose processor may be configured as respective different processing elements at different times. Software may accordingly configure the processor to constitute a particular hardware configuration at one instance of time and to constitute a different hardware configuration at a different instance of time.

Computer hardware components, such as communication elements, memory or memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory or memory device to which it is communicatively coupled. A further computer hardware component may then, at a later time, access the memory to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processors or processing element-implemented hardware modules. The performance of certain of the operations may be distributed among the one or more processing elements or processors, not only residing within a single machine, but deployed across a number of machines. In some example embodiments, the processor or processing elements may be located in a single location (e.g., within a home environment, an office environment or as a server farm), while in other embodiments the processor or at least some of its processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed, and substitutions made herein, without departing from the scope of the technology as recited in the claims.

1. A method of manufacturing a composite part, the method comprising:
applying thermocouples to a plurality of locations on a composite material;
applying curing heat to the composite material;
determining, at predetermined time intervals, a predicted percentage of cure of the composite material based on a current temperature sensed by at least one of the thermocouples, what type of material the composite material comprises, and a curing model corresponding to the type of material the composite material comprises; and
removing heat from the composite material when the predicted percentage of cure reaches a predetermined percentage of cure.

2. The method of claim 1, further comprising identifying one of the thermocouples with a lower temperature than all others of the thermocouples after a predetermined time segment as a lagging thermocouple, wherein the at least one of the thermocouples is the lagging thermocouple.

3. The method of claim 1, wherein the curing model is a statistical model developed by testing, for a range of different thermal ramp up speeds and hold temperatures, differential scanning calorimetry (DSC) of a polymer of the type of material that the composite material comprises to determine an amount of energy the polymer outputs per unit mass.

4. The method of claim 1, wherein the curing model is selected from a plurality of statistical models each developed by testing, for a range of different thermal ramp up speeds and hold temperatures, differential scanning calorimetry (DSC) for one of a plurality of polymers to determine an amount of energy the one of the plurality of polymers outputs per unit mass, such that the plurality of statistical models simulate a polymer sample of a known weight at a range of thermal ramps and hold temperatures.

5. The method of claim 4, wherein the determining at the predetermined time intervals the predicted percentage of cure of the composite material further includes interpolating data associated with the curing model to predict an amount of time left before the predicted percentage of cure reaches the predetermined percentage of cure.

6. The method of claim 1, wherein the applying of the curing heat comprises ramping up to a cure temperature at a predetermined rate and holding at the cure temperature until the predicted percentage of cure reaches the predetermined percentage of cure.

7. The method of claim 1, further comprising training the curing model based on one or more estimated kinetic parameters identified by a differential scanning calorimeter using the Borchardt and Daniels Method.

8. The method of claim 1, wherein the heat source comprises a plurality of heat zones each having independent temperature control, wherein at least some of the thermocouples are located at different ones of the plurality of heat zones.

9. The method of claim 8, further comprising determining, at the predetermined time intervals, zone-specific predicted percentages of cure of the composite material on each of the plurality of heat zones based on temperatures sensed by each of the thermocouples and the curing model; and instructing each of the plurality of heat zones of the heat source independently to turn off when a corresponding one of the zone-specific predicted percentages of cure reaches the predetermined percentage of cure.

10. A system for manufacturing a composite part, the system comprising:
a composite material;
thermocouples at a plurality of locations on the composite material;
a heat source configured to apply curing heat to the composite material;
a processor at least one of electrically and communicably coupled to the heat source and the thermocouples, wherein the processor is configured to automatically:
identify one of the thermocouples with a lower temperature than all others of the thermocouples after a predetermined time segment as a lagging thermocouple,
determine at predetermined time intervals a predicted percentage of cure of the composite material based on a current temperature sensed by the lagging thermocouple, what type of material the composite material comprises, and a curing model for the type of material the composite material comprises, and
instruct the heat source to turn off when the predicted percentage of cure reaches a predetermined percentage of cure.

11. The system of claim 10, wherein the curing model is a statistical model developed by at least one of a) dynamic mechanical analysis (DMA) and b) testing, for a range of different thermal ramp up speeds and hold temperatures, differential scanning calorimetry (DSC) of a polymer of the type of material that the composite material comprises to determine an amount of energy the polymer outputs per unit mass.

12. The system of claim 10, wherein the curing model is selected from a plurality of statistical models each developed by testing, for a range of different thermal ramp up speeds and hold temperatures, differential scanning calorimetry (DSC) for one of a plurality of polymers to determine an amount of energy the one of the plurality of polymers outputs per unit mass, such that the plurality of statistical models simulate a polymer sample of a known weight at a range of thermal ramps and hold temperatures.

13. The system of claim 12, wherein the processor is further configured to automatically interpolate data associated with the curing model to predict at least one of a cure kinetic state of a matrix of the composite material and an amount of time left before the predicted percentage of cure reaches the predetermined percentage of cure at the current temperature of the lagging thermocouple.

14. The system of claim 10, wherein the heat source comprises a plurality of heat zones each having independent temperature control, wherein at least some of the thermocouples are located at different ones of the plurality of heat zones.

15. The system of claim 14, wherein the processor is further configured to: determine at the predetermined time intervals zone-specific predicted percentages of cure of the composite material on each of the plurality of heat zones based on temperatures sensed by each of the thermocouples, what type of material the composite material comprises, and the curing model for the type of material the composite material comprises, and instruct each of the plurality of heat zones of the heat source independently to turn off when a corresponding one of the zone-specific predicted percentages of cure reaches the predetermined percentage of cure.

16. A computer-implemented method for controlling curing time of a composite part, the method comprising:
receiving, with a processor, a plurality of temperature readings from a plurality of thermocouples located at a plurality of locations on a composite material, while curing heat is applied to the composite material by a heat source;
identifying, with the processor, one of the plurality of thermocouples with a lower temperature than all others of the plurality of thermocouples, after a predetermined time segment, as a lagging thermocouple;
generating at predetermined time intervals, via the processor, a predicted percentage of cure of the composite material based on a current temperature sensed by the lagging thermocouple and a curing model for the type of material the composite material comprises; and
instructing, via the processor, the heat source to stop heating the composite material when the predicted percentage of cure reaches a predetermined percentage of cure.

17. The method of claim 16, further comprising training, by the processor, the curing model, wherein the training comprises determining an amount of energy a polymer sample outputs per unit mass for a range of different thermal ramp up speeds and hold temperatures via differential scanning calorimetry (DSC) of the polymer sample of a known weight, wherein a polymer of the polymer sample is the type of material that the composite material comprises.

18. The method of claim 16, further comprises receiving input regarding the type of material that the composite material comprise and selecting the curing model from a plurality of statistical models based on the type of material.

19. The method of claim 16, wherein during the generating step, the processor automatically interpolates data associated with the curing model to predict an amount of time left before the predicted percentage of cure reaches the predetermined percentage of cure.

20. The method of claim 16, wherein the heat source comprises a plurality of heat zones each having independent temperature control, wherein at least some of the thermocouples are located at different ones of the plurality of heat zones, wherein the method of claim 16 further comprises:
determining, with the processor, at the predetermined time intervals, zone-specific predicted percentages of cure of the composite material on each of the plurality of heat zones based on temperatures sensed by each of the thermocouples and the curing model; and
instructing, via the processor, each of the plurality of heat zones of the heat source to independently turn off when a corresponding one of the zone-specific predicted percentages of cure reaches the predetermined percentage of cure.
